(19) United States
(12) Patent Application Publication
(10) Pub. No.: US 2006/0164337 A1
(43) Pub. Date: Jul. 27, 2006

(54) Device for driving capacitive light-emitting elements

(75) Inventor: Takashi Iwami, Yamanashi (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 11/333,417

(22) Filed: Jan. 18, 2006

(30) Foreign Application Priority Data
Jan. 24, 2005 (JP) 2005-015656

(51) Int. Cl. G09G 3/28

(52) U.S. Cl. 345/60

(57) ABSTRACT

A device for driving capacitive light-emitting elements, includes the power source circuit having a series connection circuit of a capacitor and a coil, a first switching element connected between one end of the series connection circuit and a ground, a DC power source that generates a first potential, and a second switching element connected between the DC power source and a power supply line, and the output circuit having a third switching element that connects between the power supply line and an electrode in accordance with a data pulse, and a fourth switching element that selectively grounds the electrode.

### BACKGROUND OF THE INVENTION

1. Field of the Invention

The present invention relates to a device for driving capacitive light-emitting elements.

2. Description of the Related Background Art

Recently, there are commercially-available display panels made up by capacitive light-emitting elements, e.g. plasma display panels (hereinafter, referred to as PDPs) or electroluminescence display panels (hereinafter, referred to as ELPs), as wall-mounted televisions.

FIG. 1 shows a schematic arrangement of a conventional plasma display apparatus using a PDP as a display panel (e.g. apparatus disclosed in Japanese Patent Application Kokai No. 2002-156941).

In FIG. 1, a PDP 10 has row electrodes Y₁-Yₙ and X₁-Xₙ whose X-and-Y pairs respectively constitute row electrodes corresponding to the 1-st to n-th display lines of the screen. Furthermore, the PDP 10 is formed with column electrodes Z₁-Zₘ intersecting with the row electrodes and corresponding to the columns (1-st to m-th columns) of the screen. A dielectric layer and a discharge space, not shown are provided between each of the column electrodes Z₁-Zₘ and each of the row electrodes (X, Y) pairs. The PDP 10 has discharge cells which are formed at the intersections of between the row electrode (X, Y) pairs and the column electrodes Z₁-Zₘ.

A row electrode driving circuit 30 generates a sustain pulse and applies the sustain pulse to the row electrodes X₁-Xₙ of the PDP 10, to cause repetitive discharges only at discharge cells where wall charge remains. A row electrode driving circuit 40 generates and applies to the row electrodes Y₁-Yₙ, a reset pulse to initialize all the discharge cells in a simultaneous reset stage, a scanning pulse to sequentially select display lines to which pixel data is to be written in an address stage, and a sustain pulse to cause a repetitive discharge only at the discharge cells where wall charge remains in a sustain stage.

A driving control circuit 50 converts an input video signal into for example, 8-bit pixel data for each pixel and divides the pixel data for each bit digit, to obtain pixel-data bits DB. In the address stage, the driving control circuit 50 supplies, for each of the display lines, the pixel-data bits DB₁-DBₘ corresponding to the 1-st to m-th columns, to a column electrode driving circuit 20. Furthermore, in this duration, the driving control circuit 50 generates switching signals SW₁-SW₃ as shown in FIG. 2 and supplies those signals to the column driving circuit 20. Note that, FIG. 2 shows only scanning periods CYC1-CYC7 for 7 display lines of the n display lines.

FIG. 3 shows an internal configuration of the column electrode driving circuit 20.

As shown in FIG. 3, the column electrode driving circuit 20 is configured with a power source circuit 21 that generates a resonance pulse having a predetermined amplitude and applies the resonance pulse onto a power supply line 2, and a pixel data pulse generating circuit 22 that generates a pixel data pulse based on a voltage of the resonance pulse.

The capacitor C1 in the power source circuit 21 has one electrode provided with a ground potential Vs for the PDP 10. A switching element S1 is controlled to turn on/off in accordance with a switching signal SW₁ supplied from the driving control circuit 50. When the switching element S1 turns on, a voltage generated on the other electrode of the capacitor C1 is applied onto the power supply line 2 through a coil L1 and diode D1. A switching element S2 is controlled to turn on/off in accordance with a switching signal SW2 supplied from the driving control circuit 50. When the switching element S2 turns on, a voltage on the power supply line 2 is applied to the other electrode of the capacitor C1 through a coil L2 and diode D2, thus charging the capacitor C1. A switching element S3 is controlled to turn on/off in accordance with a switching signal SW3 supplied from the driving control circuit 50. When the switching element S3 turns on, a power voltage Va generated from a DC (direct current) power source B1 is applied onto the power supply line 2. The DC power source B1 has a negative electrode terminal grounded at the ground potential Vs.

By the above operation of the power source circuit 21, a voltage V1 of the resonance pulse having a maximum voltage equal to the power-source voltage Va is generated on the power supply line 2, as shown in FIG. 2.

The pixel data pulse generating circuit 22 has switching elements SWZ₁-SWZₘ and SWZ₁₀-SWZₘ₀ that are independently controlled to turn on/off in accordance with pixel data bits DB₁-DBₘ of one display line (m bits) supplied from the driving control circuit 50. Each of the switching elements SWZ₁-SWZₘ turns on when each of the supplied pixel data bits DB₁-DBₘ is at logical level “1”, to apply the resonance-pulse-based voltage on the power supply line 2 to the column electrodes Z₁-Zₘ. Note that FIG. 2 shows on/off operations of SWZᵢ of the switching elements SWZ₁-SWZₘ and of SWZₘᵢ of the switching elements SWZ₁₀-SWZₘ₀.

Here, the switching elements S1-S3, which are switched for generating the resonance pulse, are each practically comprised of FET (field effect transistor). The switching element S2 performs a switching operation based on a reference potential which is the potential on the one electrode of the capacitor C1. For this reason, a capacitor having a large capacitance has been used for the capacitor C1 in order to stabilize the operation of the switching S2 by reducing a variation of the reference potential.

However, a capacitor having a large capacitance is large in shape, implying a problem that a resulting driving device is increased in size.

### SUMMARY OF THE INVENTION

It is an object of the present invention to provide a driving device for driving capacitive light-emitting elements, that can be reduced in size.

A device for driving a display panel according to the invention comprises: a power source circuit which generates a resonance pulse having a resonant amplitude of a predetermined first potential as a maximum potential level thereof to apply the resonance pulse onto a power supply line; and an output circuit which applies a data pulse to an electrode of a display panel formed with capacitive light-emitting elements by connecting between the electrode and the power supply line in accordance with display data based on an input video signal, a controller which controls the power source circuit and the output circuit, wherein the power source circuit includes a series connection circuit having a capacitor and a coil connected in series and having one end connected to the power supply line, a first switching element connected between the other end of the series connection circuit and a ground, a direct current power source for generating a first potential, and a second switching element connected between the direct current power source and the power supply line; the output circuit includes a third switching element for connecting between the power supply line and the electrode in accordance with the data pulse, and a fourth switching element for selectively grounding the electrode; and the controller allows the output circuit to apply the data pulse to the electrode by executing, in order, a first driving stage for turning on only the third switching element of the first to fourth switching elements, a second driving stage for turning on only the second and third switching elements of the first to fourth switching elements and a third driving stage for turning on only the first and third switching elements of the first to fourth switching elements.

### BRIEF DESCRIPTION OF THE DRAWINGS

FIG. 1 is a diagram showing a schematic arrangement of a plasma display apparatus;

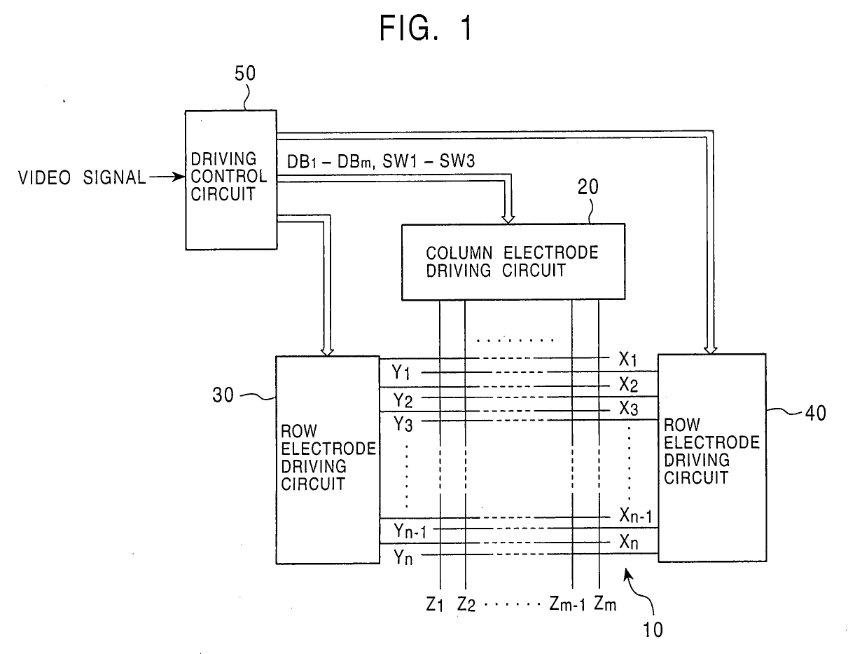

FIG. 2 is a diagram showing switching signals SW1-SW3 in the apparatus of FIG. 1 and the operation of a column electrode driving circuit;

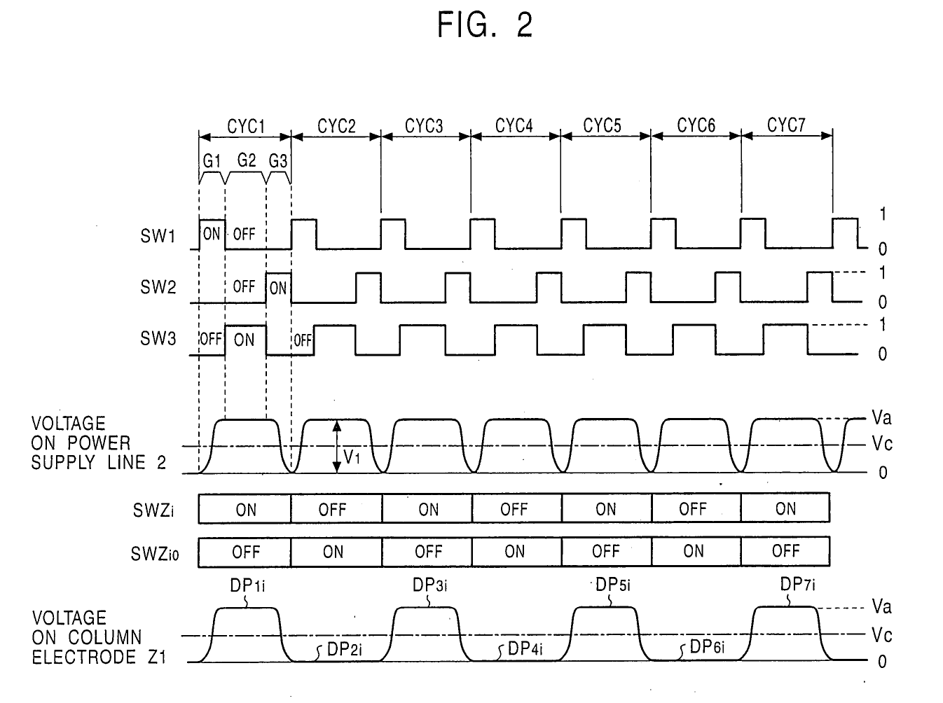

FIG. 3 is a diagram showing an internal configuration of a column electrode driving circuit in the apparatus of FIG. 1;

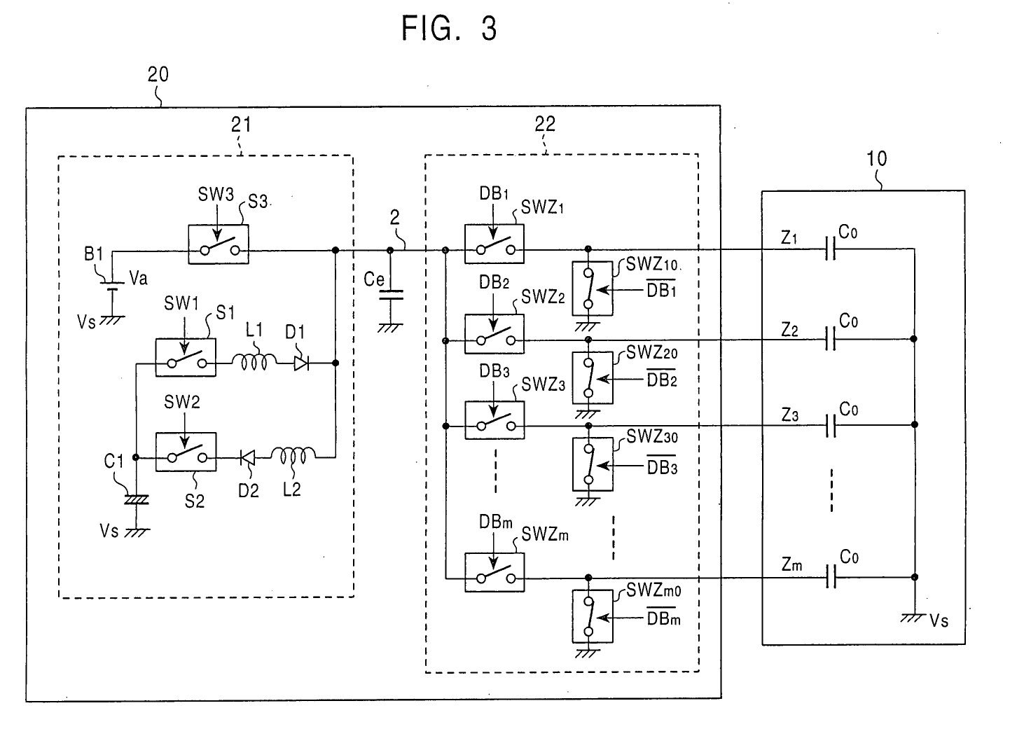

FIG. 4 is a diagram showing an arrangement of a plasma display apparatus mounted with a driving device according to the present invention;

FIG. 5 is a diagram showing various driving pulses, in one sub-field, to be applied to a PDP;

FIG. 6 is a diagram showing an internal configuration of a column electrode driving circuit in the apparatus of FIG. 4;

FIG. 7 is a figure showing the operation of the column electrode driving circuit including switching signals SW1-SW3 in FIG. 6;

FIG. 8 is a diagram showing another configuration of the column electrode driving circuit in the apparatus of FIG. 4; and

FIG. 9 is a figure showing the operation of the column electrode driving circuit in FIG. 8.

### DETAILED DESCRIPTION OF THE INVENTION

Embodiments of the present invention will be described in detail with reference to the drawings.

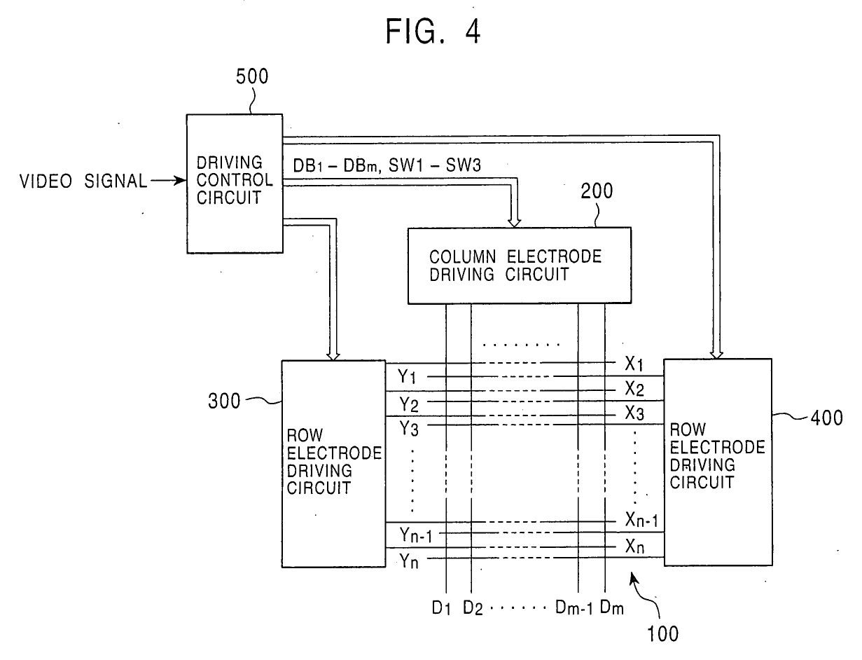

FIG. 4 shows a plasma display apparatus to which a driving device of the invention is applied. The plasma display apparatus has a PDP 100, a column electrode driving circuit 200, row electrode driving circuits 300, 400 and a driving control circuit 500.

The PDP 100 has row electrodes Y₁-Yₙ and X₁-Xₙ constituting X-and-Y pairs respectively serving for 1-st to n-th display lines of the screen. Furthermore, the PDP 100 is formed with column electrodes D₁-Dₘ orthogonal to the row electrode pairs and corresponding to the 1-st to m-th columns of the screen. A dielectric layer and a discharge space, not shown are provided between each of the column electrodes D₁-Dₘ and each of the row electrodes (X, Y) pairs. The PDP 10 has discharge cells which are formed at the intersections of between the row electrode (X, Y) pairs and the column electrodes D₁-Dₘ.

The driving control circuit 500 generates various timing signals for grayscale-driving the PDP 100 based on a sub-field method and supplies those to the row electrode driving circuits 300 and 400. The driving control circuit 500 divides the pixel data of each pixel based on an input video signal, for each bit digit to generate pixel data bits DB. Then, the driving control circuit 500 supplies for each one display line, pixel data bits DB (DB₁-DBₘ) to the column electrode driving circuit 200, together with switching signals SW2-SW4.

The column electrode driving circuit 200 generates pixel data pulses (referred later) in accordance with the switching signals SW1-SW3 and pixel data bits DB₁-DBm, and applies those to the column electrodes D1-Dm of the PDP 100. The row electrode driving circuits 300 and 400 generate various drive pulses (referred later) in accordance with the various timing signals supplied from the driving control circuit 500, and applies those to the row electrodes X, Y of the PDP 100. Note that, in the grayscale-driving based on the sub-field method, one-field period of the input video signal is divided into a plurality of sub-fields, to carry out a light-emission driving for the discharge cells in each of the sub-fields.

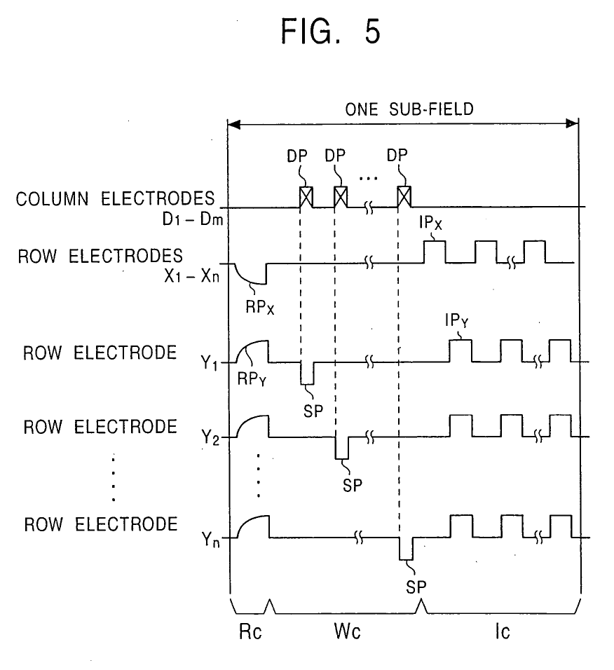

FIG. 5 shows an example of the drive pulses to be applied, in one sub-field, by the row electrode driving circuit 200 and the column electrode driving circuits 300 and 400.

As shown in FIG. 5, the one sub-field is constituted with a simultaneous reset stage Rc, an address stage Wc and a sustain stage Ic.

In the simultaneous reset stage Rc, the row electrode driving circuit 300 generates a reset pulse RP_{X} as shown in FIG. 5 and applies it to the row electrodes X₁-Xₙ of the PDP 100. In the simultaneous reset stage Rc, the row electrode driving circuit 400 generates a reset pulse RP_{Y} as shown in FIG. 5 in the same timing as the reset pulse RP_{X} and applies it to the row electrodes Y₁-Yₙ of the PDP 100. Due to the applications of the reset pulses RP_{X} and RP_{Y}, a reset discharge occurs in all the discharge cells, thus forming uniformly wall charge in the discharge cells.

In address the Wc, the row electrode driving circuit 400 generates a scanning pulse SP as shown in FIG. 5 and applies it, in order, to the row electrodes Y₁-Yₙ of the PDP 100 as shown in FIG. 5. In the address stage Wc, the column electrode driving circuit 200 generates m pixel data pulses DP having pulse voltages respectively corresponding to logical levels of the pixel data bits DB₁-DBₘ synchronously with the application timing of the scanning pulse SP, and applies those to the column electrodes D₁-Dₘ, respectively. For example, the column electrode driving circuit 200 first applies, to the column electrodes D₁-Dₘ, m pixel data pulses DP corresponding to the first display line synchronously with the timing of the scanning pulse SP applied to the row electrode Y1, as shown in FIG. 5. Then, as shown in FIG. 5, m pixel data pulses DP corresponding to the second display line, are applied respectively to the column electrodes D₁-Dₘ synchronously with the timing of the scanning pulse SP applied to the row electrode Y2. In the address stage Wc, an erase discharge selectively takes place in a discharge cell to which a high-voltage pixel data pulse has been applied simultaneously with a scanning pulse SP, thus clearing of the wall charge formed in the discharge cell. On the other hand, no erase discharge is generated within a discharge cell to which a low-voltage pixel data pulse has been applied despite a scanning pulse SP has been applied, so that the wall charge remains in the discharge cell.

In the sustain stage Ic, the row electrode driving circuits 300 and 400 alternately, repeatedly generate sustain pulses IP_{X} and IP_{Y} and applies those to the row electrodes X₁-Xₙ and Y₁-Yₙ, respectively, as shown in FIG. 5. Each time the sustain pulse IP_{X} and IP_{Y} is applied, a sustain discharge takes place within the discharge cell where the wall charge remains, thus maintaining a light emission state due to the discharge.

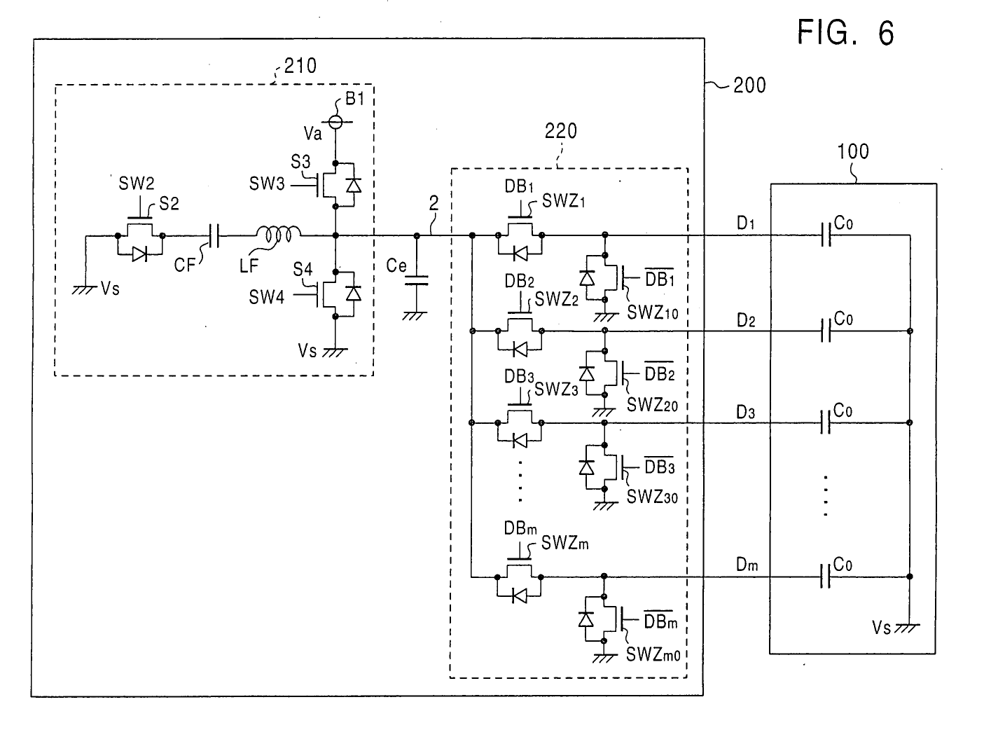

FIG. 6 shows an internal configuration of the column electrode driving circuit 200 for generating the pixel data pulses as mentioned above.

As shown in FIG. 6, the column electrode driving circuit 200 is configured with a power source circuit 210 for generating, as a power voltage, a resonance pulse having a predetermined amplitude and a pixel data pulse generating circuit 220 for generating a pixel data pulse based on the resonance pulse.

The power source circuit 210 has switching elements S2-S4 which are FETs (field effect transistors), a capacitor CF and a coil LF. The switching element S3, as a second switching element, has a source electrode connected to a positive electrode terminal of a DC (direct current) power source B1 and a drain electrode connected to a power supply line 2. The switching element S3 also has a gate electrode to which the switching signal SW3 is supplied from the driving control circuit 500. The switching element S3 becomes off when the switching signal SW3 is at logical level “0”. Meanwhile, it becomes on when at logical level “1”, to apply a power voltage Va (first potential) generated from the DC power source B1 onto the power supply line 2. The switching element S4, as a fifth switching element, has a source electrode supplied with the ground potential Vs and a drain electrode connected to the power supply line 2. The driving control circuit 500 supplies the switching signal SW4 to a gate electrode of the switching element S4. The switching element S4 becomes off when supplied with the switching signal SW4 having logical level “0”. Meanwhile, when supplied with the switching signal SW4 having logical level “1”, the switching element S4 becomes on, thus setting the power supply line 2 to the ground potential Vs.

The switching element S2, as a first switching element, has a source electrode to which the ground potential Vs is supplied, and a drain electrode connected to one end of the capacitor CF. The switching element S2 has also a gate electrode to which the switching signal SW2 is supplied from the driving control circuit 500. The capacitor CF has the other end connected to one end of the coil LF. The coil LF has the other end connected to the power supply line 2. The coil LF and capacitor CF constitute a series connection circuit.

The pixel data pulse generating circuit 220 has switching elements SWZ₁-SWZₘ (third switching elements) and SWZ₁₀-SWZₘ₀ (fourth switching elements) each of which are controlled to turn on/off in accordance with the pixel data bits DB₁-DBₘ supplied from the driving control circuit 500. The switching elements SWZ₁-SWZₘ become on only when each of the pixel data bits DB₁-DBₘ supplied is at logical level “1”, to apply a voltage on power supply line 2, based on a resonance pulse, to the column electrodes D₁-Dₘ of the PDP 100. Meanwhile, the switching elements SWZ₁₀-SWZₘ₀ become on only when each of the pixel data bits DB₁-DBₘ is at logical level “0”, to set the column electrodes D₁-Dₘ at the ground potential Vs.

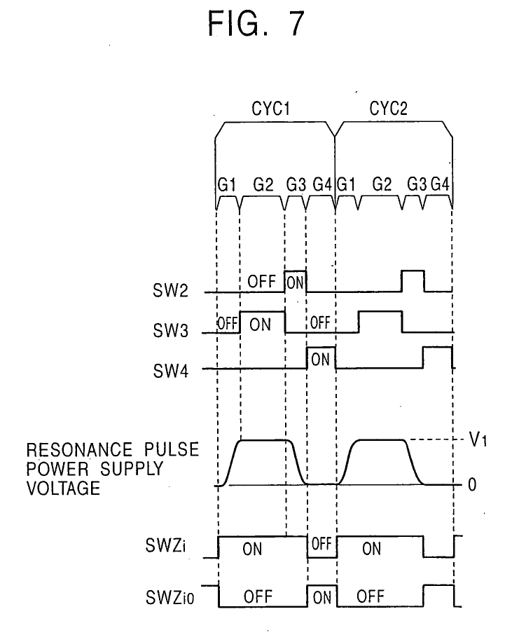

FIG. 7 shows on/off control of the switching elements S3-S4 as well as on/off control of one element SWᵢ of the switching elements SW₁-SWZₘ and one element SWZₘᵢ of the switching elements SWZ₁₀-SWZₘ₀, in two scanning periods during the address stage. Each of the scanning periods is constituted with consecutive four driving stages G1-G4. Note that FIG. 7 shows only the scanning periods CYC1, CYC2 corresponding to continuous two lines of the n display lines. Each of the scanning periods CYC1, CYC2 is at the case that a resonance-pulse-based voltage is applied to one column electrode Di of the column electrodes D₁-Dₘ.

In FIG. 7, the driving control circuit 500 first supplies the switching signals SW2-SW4 having logical level “0” to the switching elements S2-S4, respectively, to set all the switching elements S2-S4 to turn off (driving stage G1). During the driving stage G1, in the case the switching element SWZᵢ is set to turn on and SWZ₁₀ to off, charge stored on the capacitor CF discharges. A current based on the discharge flows onto the power supply line 2, to increase the voltage on the power supply line 2, as shown in FIG. 7. The increase in voltage forms the front edge of a resonance pulse. During the driving stage G1, the voltage of the resonance pulse front edge is applied to the column electrode Di.

Then, the driving control circuit 500 changes the switching signal SW3 to logical level “1” to set the switching element S3 to turn on (driving stage G2). In response to the execution of the driving stage G2, the power voltage Va generated from the DC power source B1 is applied onto the power supply line 2. During the driving stage G2, the voltage on the power supply line 2 is fixed at the power voltage Va providing the maximum voltage in the resonance pulse having a resonant amplitude V1. During the driving stage G2, the switching element SWZᵢ maintains on while SWZ₁₀ maintains off, thus applying the power voltage Va to the column electrode Di.

The driving control circuit 500 changes the switching signal SW3 to logical level “0” and the switching signal SW2 to logical level “1” (driving stage G3). In response to a transition into a driving stage G3, the switching element S2 solely turns on, to set the one end of the capacitor CF to the ground potential Vs. As a result, a current flows from the power supply line 2 to the capacitor CF through the coil LF, to charge the capacitor CF. Due to charging to the capacitor CF, the voltage on the power supply line 2 gradually decreases as shown in FIG. 7. The decrease in voltage provides the rear edge of the resonance pulse. During the driving stage G3, the voltage of the resonance pulse rear edge is applied to the column electrode Di.

Then, the driving control circuit 500 changes the switching signal SW2 to logical level “0” and the switching signal SW4 to logical level “1” (driving stage G4). In the driving stage G4, the driving control circuit 500 furthermore changes the switching element SWZᵢ from on to off and the switching element SWZᵢ from off to on. Accordingly, the switching elements S4 and SWZ₁₀ turn on, to set the power supply line 2 and column electrode Di to the ground potential Va (0 volt).

According to the power source circuit 210 shown in FIG. 6, since the switching element S2 always switches on/off at a threshold based on the ground potential Vs, it operates correctly regardless of the voltage variation at the voltage across the capacitor CF. Thus, it is unnecessary to increase the capacitance of the capacitor CF in order to obtain reliable switching operation of the switching element S2, thus making it possible to reduce the driving device in size.

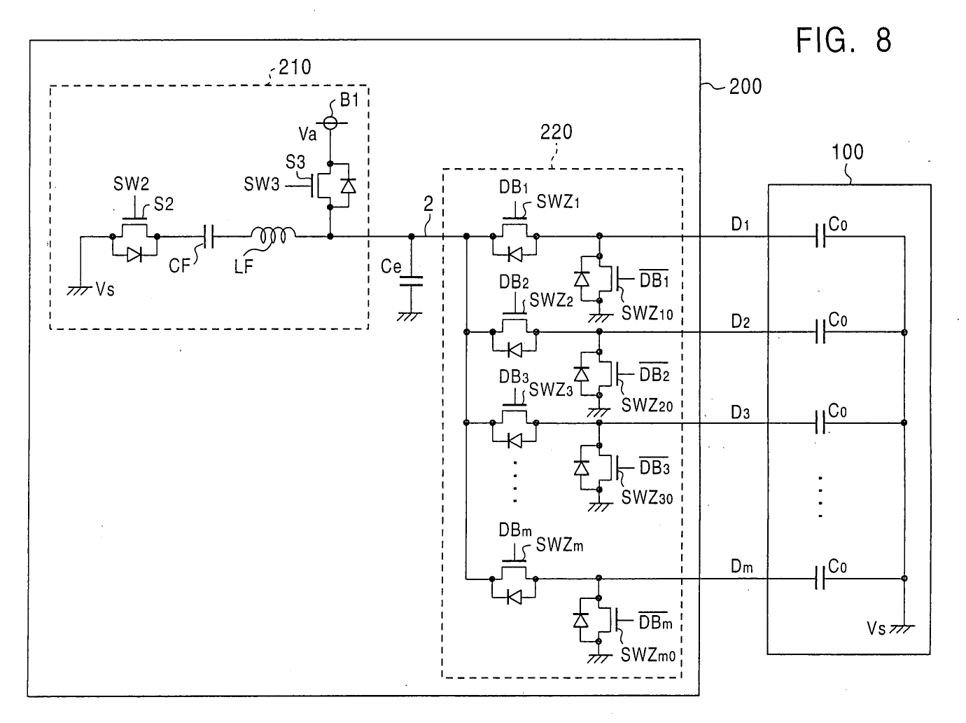

The power source circuit 210 may be in a configuration as shown in FIG. 8 by omitting the switching element S4 from the circuit in FIG. 6.

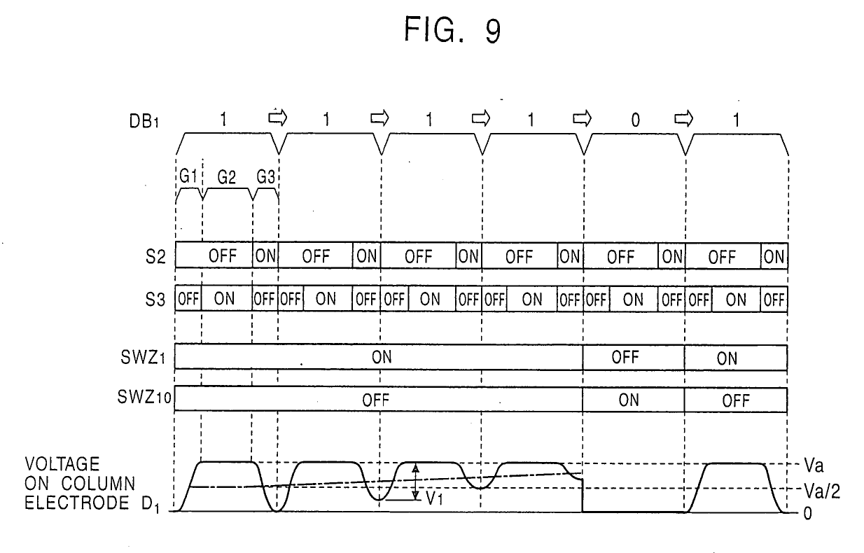

FIG. 9 shows an example of internal operation of the power source circuit 210 and pixel data pulse generating circuit 220 shown in FIG. 8. The example shown in FIG. 9 shows an extraction of the operation of the switching elements SWZ₁ and SWZ₁₀ in the pixel data pulse generating circuit 220 performed in accordance with the pixel data bit DB₁ having a bit train [1, 1, 1, 1, 0, 1]. Each scanning period is constituted by continuous three driving stages G1-G3. In a scanning period when the pixel data bit DB₁ is 1, the voltage of a resonance pulse is applied to the column electrode D₁ while, in a scanning period when the pixel data bit DB₁ is 0, the voltage of a resonance pulse is not applied to the column electrode D₁.

As shown in FIG. 9, the driving control circuit 500 first sets the both switching elements S2 and S3 of the power source circuit 210 to turn on (driving stage G1). Then, the driving control circuit 500 sets only S3 of the switching elements S2, S3 to turn on (driving stage G2). Then, the driving control circuit 500 sets only S2 of the switching elements S2, S3 to turn on (driving stage G3). The driving stage G1 and the driving stage G3 are equal in time length to each other. The driving control circuit 500 repeatedly performs a series of switching sequence of the driving stages G1-G3, correspondingly to the bits of a bit train of each of the pixel data bits DB.

The switching element SWZ₁ is set to turn off during the execution of the driving stages G1-G3 when the pixel data bit DB₁ is at logical level 0. Meanwhile, it is set to turn on during the execution of the driving stages G1-G3 when the pixel data bit DB₁ is at logical level 1. The switching element SWZ₁₀ is set to turn on during the execution of the driving stages G1-G3 when the pixel data bit DB₁ is at logical level 0. Meanwhile, it is set to turn off during the execution of the driving stages G1-G3 when the pixel data bit DB₁ is at logical level 1.

When the pixel data bit DB₁ is at logical level “1”, then, only the switching element SWZ₁ of the switching elements S2, S3, SWZ₁ and SWZ₁₀ turns on in the driving stage G1. Thus, charge stored in the capacitor CF discharges. A current based on the discharge flows into the column electrode D₁ of the PDP 100 through the coil LF, power supply line 2 and switching element SWZ₁. Consequently, the load capacitance C₀ is which parasitic in the column electrode D₁ is charged. At this time, by the resonant action of the coil LF and load capacitance C₀, the voltage on the column electrode D₁ gradually increases. Immediately before passing a time period corresponding to a half period of the resonance cycle, the driving control circuit 500 transits to an execution in the driving stage G2. In the driving stage G2, only the switching elements S3 and SWZ₁ of the switching elements S2, S3, SWZ₁ and SWZ₁₀ turn on. In this duration, the power voltage Va of the DC power source B1 is directly applied to the column electrode D₁ through the switching elements S3 and SWZᵢ. By the voltage application, the load capacitance C₀ parasitic in the column electrode D₁ of the PDP 100 is continuously charged. When a driving stage G3 is executed, the switching elements S2 and SWZ₁ of the switching elements S2, S3, SWZ₁ and SWZ₁₀ turn on, to equal the one end of the capacitor CF to the ground potential Vs. Due to this, the load capacitance C₀ of the PDP 100 begins discharging. A current based on the discharge flows to a current path of the column electrode D₁, the switching element SWZ₁, the power supply line 2, the coil LF, the capacitor CF and the switching element S2, so that charging of the capacitor CF is begun. Namely, the charge stored in the load capacitance C₀ of the PDP 100 is restored in the capacitor CF. At this time, the voltage on the column electrode D₁ gradually decreases as shown in FIG. 9 in accordance with a time constant determined by the coil LF and the load capacitance C₀.

Meanwhile, when the data bit DB₁ is at logical level 0, the switching element SWZ₁ turns off while the switching element SWZ₁₀ turns on, to ground the column electrode D₁. In this duration, the voltage on the column electrode D₁ is constant at 0 volt as shown in FIG. 9.

In the embodiment shown in FIGS. 8 and 9, one of the switching elements SWZ₁ and SWZ₁₀ is turned on, to suppress the on/off switching frequency of the switching elements SWZ₁ and SWZ₁₀, thus suppressing switching loss. Particularly, in the case of a driver IC configuration integrated with a plurality of output circuits including switching elements SWZ₁ and SWZ₁₀, the switching loss suppression effect is enhanced.

Note that, in the embodiments, the series connection circuit of the capacitor CF and coil LF, connected between the switching element S2 and the power supply line 2, provides a similar effect even where the capacitor CF and the coil LF are reversed in arrangement relationship.

According to the invention, the device for driving the capacitive light-emitting elements can be reduced in size and in cost because of no need to use a large sized capacitor for the power source circuit.

This application is based on Japanese Patent Application No. 2005-015656 which is hereby incorporated by reference.

What is claimed is:

1. A driving device for driving a display panel, comprising:
a power source circuit which generates a resonance pulse having a resonant amplitude of a predetermined first potential as a maximum potential level thereof to apply the resonance pulse onto a power supply line; and
an output circuit which applies a data pulse to an electrode of a display panel formed with capacitive light-emitting elements by connecting between said electrode and said power supply line in accordance with display data based on an input video signal,
a controller which controls said power source circuit and said output circuit, wherein
said power source circuit includes a series connection circuit having a capacitor and a coil connected in series and having one end connected to said power supply line, a first switching element connected between the other end of said series connection circuit and a ground, a direct current power source for generating a first potential, and a second switching element connected between said direct current power source and said power supply line;
said output circuit includes a third switching element for connecting between said power supply line and said electrode in accordance with the data pulse, and a fourth switching element for selectively grounding said electrode; and
said controller allows said output circuit to apply the data pulse to said electrode by executing, in order, a first driving stage for turning on only said third switching element of said first to fourth switching elements, a second driving stage for turning on only said second and third switching elements of said first to fourth switching elements and a third driving stage for turning on only said first and third switching elements of said first to fourth switching elements.

2. The driving device of claim 1, wherein said power source circuit further includes a fifth switching element connected between said power supply line and the ground.

3. The driving device of claim 1, wherein, when the data pulse is consecutively at a same logical level, said power source circuit causes the resonance pulse to have the resonant amplitude without changing the first potential as the maximum potential level.

4. The driving device of claim 2, wherein, when said display panel is driven in gray scale by constituting a 1-field display period of the input video signal by a plurality of sub-fields each including an address period and a sustain period, said fifth switching element is turned off in the address period.

5. The driving device of claim 1, wherein said output circuit including said third and fourth switching elements is configured by a semiconductor integrated circuit.
